(19) United States
(12) Patent Application Publication
(10) Pub. No.: US 2024/0187826 A1
(43) Pub. Date: Jun. 6, 2024

(54) DEVICE, NETWORK NODE, AND METHODS IN A COMMUNICATIONS NETWORK

(71) Applicant: Telefonaktiebolaget LM Ericsson (publ), Stockholm (SE)

(72) Inventors: Meeta THAKUR, Bangalore (IN); Andreas ANULF, Lidingö (SE); Håkan ÖSTERLUND, Ekerö (SE); Jörgen AXELL, Danderyd (SE); Nándor VASS, Herceghalom (HU); Darjan BOSNJAK, Bromma (SE)

(21) Appl. No.: 18/553,899

(22) PCT Filed: Apr. 9, 2021
(86) PCT No.: PCT/SE2021/050329

§ 371 Date: Oct. 4, 2023

(51) Int. Cl. H04W 4/16; H04M 3/54

(52) U.S. Cl. CPC H04W 4/16; H04M 3/54

(57) ABSTRACT

A method performed for handling an ongoing communication session with a remote party in a communication network is provided. A user is associated with a set of User Equipments, UEs, in a single user subscription. The set of UEs includes at least a first UE and a second UE. The ongoing communication session with the remote party involves the first UE. For each respective UE out of the set of UEs, information is obtained. The information is related to the respective UE's name recognizable by the user, communication capabilities, and communication session status. A user indication is obtained. The user indication is based on the received information. The indication indicates to transfer the ongoing communication session with the remote party. According to the indication, a network node is requested to transfer the ongoing communication session from the first UE to the second UE.

### TECHNICAL FIELD

Embodiments herein relate to a device, a network node and methods therein. In some aspects they relate to handling an ongoing communication session with a remote party in a communication network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specifying the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specify a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### Multimedia Telephony

Multimedia Telephony Service and supplementary services support multiple UEs under the same Internet Protocol Multimedia Subsystem (IMS) subscription. Recently the need for multiple device usage has increased, for example with smart watches and tablets, as described in 3GPP TS 22.173, “Multimedia Telephony Service and supplementary services”.

Support of multi-device enables an IMS subscriber to use UEs with different capabilities and different types, e.g. a phone, a tablet, a wearable device, or a Personal Computer (PC) as described in 3GPP TS 24.173 “IMS multimedia telephony communication service and supplementary services”.

An end user of a device in a multi-device environment, can transfer an ongoing multi-media session from one UE to another UE of the same IMS subscriber as described in 3GPP TS 24.337, “IP Multimedia Subsystem (IMS) inter-UE transfer”.

A dialog event package allows UEs of an IMS subscriber to subscribe and receive notifications of the changes in state of INVITE initiated dialogs in which the other UEs of the same IMS subscriber is involved as described in Internet Engineering Task Force (IETF), Request For Comments (RFC) 4235, “an INVITE-Initiated Dialog Event Package for the Session Initiation Protocol (SIP)”.

### SUMMARY

As a part of developing embodiments herein a problem was identified by the inventors and will first be discussed.

A UE of an IMS subscriber served by an Application Server (AS), may manipulate data related to supplementary services of a served user such as call forwarding addresses, voice mail settings etc. However, there is no mechanism for a UE to find the addresses of the other UEs in the same subscription, so all transfers of sessions between UEs is thus based on proprietary configuration in the UEs.

When trying to distinguish between UEs, e.g. when transferring a session, if devices are not named in a way recognizable by a user, it may be impossible for the user to distinguish, which device is involved with, or should be involved with, which session.

When more than one UE are connected to single IMS subscription, an end user of a UE may thus want to assign to the UE, device information, e.g. like a nick name or a descriptive name based on their usage e.g. Alice's Home Phone, Alice's Business Phone, Alice's Personal Phone etc. This device information may be needed for a user to understand, for example, how to manage the transfer of sessions between devices of the user. However, there is no mechanism existing today where a UE may learn device information and capabilities of the other UEs of the same subscriber and in this way get informed when the subscriber changes the device information.

The end user of a device in a multi-device environment of an IMS subscriber, can transfer ongoing multi-media sessions from one UE to another UE of the same IMS subscriber as described in 3GPP TS 24.337. However, there is no solution for UE(s) discovery procedure when a selected UE is an unregistered Voice over LTE (VOLTE) UE on Circuit Switched (CS) access or the selected UE only has CS capability. Hence, there is no support for transfer of ongoing multi-media sessions for Non Session Continuity (NON-SC) UE and/or non-Subscriber Identity Module (SIM) devices. Hence, these devices cannot participate in an inter-UE call transfer.

Therefore, it is desirable to achieve a solution that allows for users of a UE to assign device information, e.g. names to a set of UEs within a single subscription, e.g. selectable from a GUI of the UE, to perform ongoing multi-media session transfer among the set of UEs, independent of device type, e.g. SIM/Non-SIM, and independent of attached access type, e.g. any one of Packet Switched (PS), CS, and no cellular access.

Hence, an object of embodiments herein is to increase the flexibility of handling communication sessions in a communications network.

According to an aspect of embodiments herein, the object is achieved by a method for handling an ongoing communication session with a remote party in a communication network. A user is associated with a set of UEs in a single user subscription. The set of UEs comprises at least a first UE, and a second UE. The ongoing communication session with the remote party involves the first UE. For each respective UE out of the set of UEs, information is obtained. The information relates to the respective UE's name recognizable by the user, communication capabilities, and communication session status. A user indication is obtained. The user indication is based on the received information. The user indication indicates to transfer the ongoing communication session with the remote party. According to the indication, a network node is requested to transfer the ongoing communication session from the first UE to the second UE.

According to another aspect of embodiments herein, the object is achieved by a method performed by a network node for handling an ongoing communication session with a remote party in a communication network. A user is associated with a set of UEs in a single user subscription. The set of UEs comprises at least a first UE and a second UE. The ongoing communication session with the remote party involves the first UE. For each respective UE out of the set of UEs, the network node transmits information related to the respective UE's name recognizable by the user, communication capabilities and communication session status. The information is transmitted to at least one UE out of the set of UEs. The network node receives a request from the at least one UE requesting to transfer the ongoing communication session from the first UE to the second UE. Based on the request, the network node transfers the ongoing communication session from the first UE to the second UE.

According to another aspect of embodiments herein, the object is achieved by a device configured to handle an ongoing communication session with a remote party in a communication network. A user is arranged to be associated with a set of UEs in a single user subscription. The set of UEs is adapted to comprise at least a first UE and a second UE. The ongoing communication session with the remote party is adapted to involve the first UE. The device further being configured to:

for each respective UE out of the set of UEs, obtain information related to the respective UE's name recognizable by the user, communication capabilities, and communication session status,

obtain a user indication based on the received information, which indication is adapted to indicate to transfer the ongoing communication session with the remote party, and

according to the indication, request a network node to transfer the ongoing communication session from the first UE to the second UE.

According to another aspect of embodiments herein, the object is achieved by a network node configured to handle an ongoing communication session with a remote party in a communication network. A user is arranged to be associated with a set of UEs in a single user subscription. The set of UEs is adapted to comprise at least a first UE and a second UE. The ongoing communication session with the remote party is adapted to involve the first UE. The network node further being configured to:

for each respective UE out of the set of UEs, transmit information related to the respective UE's name recognizable by the user, communication capabilities, and communication session status, which information is arranged to be transmitted to at least one UE in the set of UEs,

receive a request from the at least one UE, requesting to transfer the ongoing communication session from the first UE to the second UE, and

based on the request, transfer the ongoing communication session from the first UE to the second UE.

Since information of the respective UEs in the set of UEs is obtained, it is possible to, in a user-friendly way based on the received information, transfer an ongoing session from the first UE to the second UE. This is since the information of each respective UE may now be easily recognized by the user and associated with each respective UE's communication capabilities and session status. Hence, the user may therefore in a better manner indicate a transfer of sessions from the first UE to the second UE based on the capabilities and status of the user's UEs.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIG. 2 is a flowchart depicting an embodiment of a method herein.

FIG. 3 is a flowchart depicting an embodiment of a method in a network node FIG. 4 is a sequence diagram depicting embodiments herein.

FIG. 5 is a sequence diagram depicting embodiments herein.

FIG. 6 is a sequence diagram depicting embodiments herein.

FIG. 7 is a sequence diagram depicting embodiments herein.

FIG. 8a-b are schematic block diagrams illustrating embodiments of a function node.

FIG. 9a-b are schematic block diagrams illustrating embodiments of a function node.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12-15 are flowcharts illustrating methods implemented in a communication system including a host computer, a base station and a user equipment.

### DETAILED DESCRIPTION

Embodiments provides a way of conveying user-friendly device information to UEs in multi-device deployment. For example, embodiments herein relate to transferring an ongoing session based on the user-friendly device information. Sessions herein may e.g. be multi-media sessions, such as calls, performed in multi-device environment.

User-friendly device information when used herein means information obtained or transferred in embodiments herein. The user-friendly device information may comprise descriptive names, UE capabilities, and session status. This information may e.g. help users to better distinguish between UEs, and may help in better selecting which UE to transfer a session to. The information may e.g. enable end users of devices to visualize a holistic view of UEs information, and UE capabilities and respective dialogs status of same subscriber. Hence, in a user-friendly way, the end users may perform ongoing multi-media session transfer among them.

Due to the embodiments herein, an end user of a device will easily recognize the user's own devices within the same subscription e.g. by nick names or descriptive names e.g. assigned by the user which may be presented on a Graphical User Interface (GUI) of the device. This allows for a multi-media session transfer among the user's devices, or to join an ongoing multi-media session in a user-friendly manner.

Furthermore, embodiments herein provide flexibility to end users of devices to assign multiple pieces of information to devices of the same subscription, e.g. permanent or temporary willingness to be part of session transfer, media capabilities applicable for session transfer, attached access type of device, and/or any suitable information which may help in selecting a suitable UE for a session transfer.

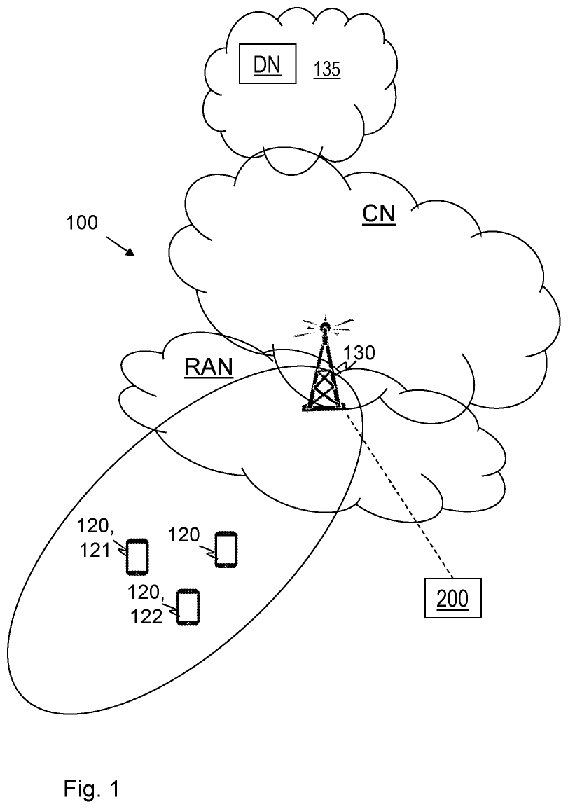

FIG. 1 is a schematic overview depicting a communications network 100 wherein embodiments herein may be implemented. The communications network 100 may be a wireless communications network. The communications network 100 may also comprise wired connections. The communications network 100 may comprise one or more RANs and one or more CNs. The communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the communications network 100 such as e.g. a network node 130. These nodes may provide radio coverage in a number of cells which may also be referred to as a beam or a beam group of beam. The network node 130 may e.g. be a Multimedia Telephony Application Server (MMTel AS). The network node 130, may alternatively or additionally be any of a NG-RAN node, an IMS node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNodeB B), a gNB, a base transceiver station, a radio remote unit, an Access Point Base Station, a base station router, a transmission arrangement of a radio base station, a stand-alone access point or any other network unit capable of communicating with a wireless device within the service area served by the network node 130 depending e.g. on the first radio access technology and terminology used.

The network node may e.g. control sessions, e.g. involving a UE, e.g. a first UE 120, 121 and/or a second UE 120, 122, and a remote party 200. This means that if there is a session involving the first UE 120, 121 and the remote party 200, multimedia may be transferred between the remote party 200 and the first UE 120, 121, via the network node 130.

In the communication network 100, the remote party 200 operate. This may be any device capable of having an ongoing communications session with UEs in the communications network 100, e.g. any of the first UE 120, 121 and/or the second UE 120, 122.

In the communication network 100, one or more UEs operate, e.g. a set of UEs 120, 121, 122. The set of UEs comprises one or more UEs, such as e.g. the first UE 120, 121 and the second UE 120, 122. UEs herein, e.g. the first and second UEs 120, 121, 122, may respectively be referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, car phone, Personal Digital Assistant (PDA), home phone, smart watch, laptop, mobile phone, sensor, relay, mobile tablets or even a small base station communicating within a cell. In scenarios and embodiments herein, UEs may interchangeably be referred to a device, and vice versa.

Methods herein may be performed by a device 120, 121, 122, the device may be a UE, e.g. represented by the first UE 120, 121, or the second UE 120, 122. The device may also be represented by any other UE in the set of UEs 120, 121, 122.

Methods herein may additionally or alternatively be performed by the network node 130.

As an alternative, a Distributed Node (DN) and functionality, e.g. comprised in a cloud 135 as shown in FIG. 1, may be used for performing or partly performing the methods herein. In particular, a session transfer functionality of embodiments herein may be centralized be the responsibility of the network node 130. Such functionalities may be particularly suitable to be distributed in any suitable manner across several nodes.

A number of embodiments will now be described, some of which may be seen as alternatives, while some may be used in combination.

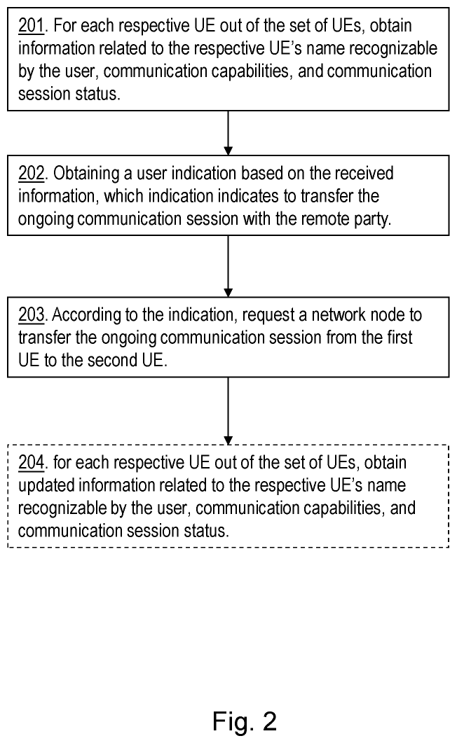

FIG. 2 shows example embodiments of a method for handling an ongoing communication session with the remote party 200 in the communication network 100. A user Alice is associated with a set of UEs 120, 121, 122 in a single user subscription. The set of UEs 120, 121, 122 comprises at least the first UE 120, 121 and the second UE 120, 122. The ongoing communication session with the remote party 200 involves the first UE 120, 121. This means that a there the ongoing communication session is between the first UE 120, 121 and the remote party 200. The method comprises the following actions, which actions may be taken in any suitable order. Optional actions are referred to as dashed boxes in FIG. 2.

In some embodiments, the method may be performed by any one out of the device 120, the first UE 120, 121, and the second UE 120, 122. In some of these embodiments, the device 120 may be a UE out of the set of UEs 120, 121, 122, e.g. the first UE 120, 121 or the second UE 120, 122. In some other embodiments, the device may also be any other UE out of the set of UEs 120, 121, 122, e.g. a third UE out of the set of UEs 120, 121, 122.

### Action 201

For each respective UE out of the set of UEs 120, 121, 122, information is obtained. The information is related to the respective UE's name recognizable by the user Alice, communication capabilities, and communication session status. This enables, e.g. a user or a UE such as the first UE 120, 121 and/or second UE 120, 122, to differentiate the UEs in the set of UEs 120, 121, 122 more efficiently and select where to transfer a session based on the respective UEs capabilities and status.

In some embodiments, the communication session status comprises any one or more out of: Whether being involved in the ongoing session, whether not being involved in the ongoing session, and a current status of another session than the ongoing session. In this way, it is possible to select where to transfer a session based on details of the communication session status. E.g. to not disturb and/or terminate other sessions, it may be beneficial to transfer a session to a UE which is not involved in any session.

In some embodiments, the name recognizable by the user Alice is any one out of:
a descriptive name set by a user, e.g. by the user Alice,
a descriptive name set by an operator, and
a descriptive name automatically generated e.g. the name may be preconfigured from the manufacturer.

In some embodiments, information related to the respective UE's name recognizable by the user Alice, communication capabilities, and communication session status, further comprises device information, wherein the device information comprising any one or more out of:
a tag indicating the UE supports one or more types of media,
a tag indicating the UE supports one or more types of communication, and
a tag indicating the UE have registered one or more capabilities associated with the UE.

A tag when used herein means a parameter that has a name and a corresponding value. In some of embodiments, the tag may indicate willingness or ability to be part of a session transfer permanently or within a certain time period. In some of embodiments, the tag may be an indicator comprising information, e.g. such as a code and/or a set of bits.

Hence, information comprised in the tag enables more knowledge of the respective UE in the set of UEs 120, 121, 122, and thus it is possible to transfer a session depending on more parameters comprised in the tag. E.g. the user Alice may select to push a session to a UE such as the second UE 120, 122, supporting video. In another example, the tag indicates that a respective UE in the set of UEs 120, 121, 122, is in CS access willing to be part of a specific media type session transfer.

In some embodiments, the information is obtained by retrieving the information from the device 120, 121, 122 performing the method, or receiving the information from the network node 130. In other words, some of the information may already be known by the device performing the method, e.g. the device 120, the first UE 120, 121, or the second UE 120, 122 and therefore only some of the information is needed to be received by the network node 130. E.g. in some embodiments, the device 120, 121, 122 performing the method already have current information about itself.

In some embodiments, the received information is presented by the first UE 120, 121 or the second UE 120, 122 to be recognized by the user Alice. This may e.g. be displayed on a display on a device 120, 121, 122, e.g. presented on a graphical user interface on a display of any one out of the device 120, the first UE 120, 121, or the second UE 120, 122. In some embodiments, the information may also be presented non-visually, e.g. presented by audio read out by a device, e.g. any one out of the device 120, the first UE 120, 121, or the second UE 120, 122.

In some embodiments, the information reflects changes relating to the set of UEs 120, 121, 122, e.g. name changes of any UE out of the set of UEs 120, 121, 122. In other words, the UEs may change information, e.g. which triggers sending the information to the other UEs in the set of UEs 120, 121, 122. This may be, e.g. when a user changes descriptive names of its devices, e.g. using the first UE 120, 121.

### Action 202

A user indication is obtained. The user indication is based on the received information. The user indication indicates to transfer the ongoing communication session with the remote party 200. In other words, the obtained user indication may e.g. be a selection by a user which UE in the set of UEs 120, 121, 122, that is preferred when to push and/or pull the ongoing session to or from. The preferred UE may e.g. be selected from a list comprising the received information. The indication may in some embodiments indicate a call push from the first UE 120, 121 to the second UE 120, 122. The indication may in some embodiments indicate a call pull from the second UE 120, 122 to the first UE 120, 121.

### Action 203

According to the indication, a network node 130 is requested to transfer the ongoing communication session from the first UE 120, 121 to the second UE 120, 122. The network node 130 may then transfer the ongoing communication session, e.g. a multimedia call to the remote party 200, from the first UE 120, 121 to the second UE 120, 122

### Action 204

In some embodiments, when the ongoing communication session has been transferred, for each respective UE out of the set of UEs 120, 121, 122, updated information is obtained. In these embodiments, the updated information is related to the respective UE's name recognizable by the user Alice, communication capabilities, and communication session status.

In this way, updated information is received and better knowledge of the set of UEs 120, 121, 122 is achieved, e.g. to be used for further session transfers. The updated information may reflect, e.g. changes due to the session transfer and/or other changes relating to the set of UEs, e.g. name changes of any UE out of the set of UEs 120, 121, 122.

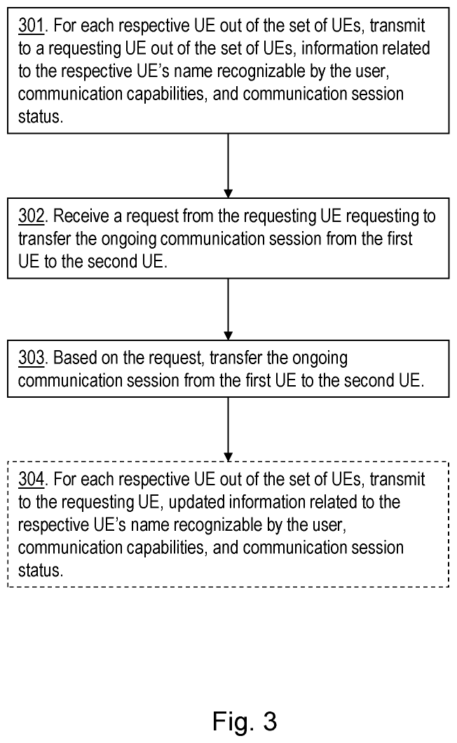

FIG. 3 shows example embodiments of a method performed by the network node 130, for handling an ongoing communication session with the remote party 200 in the communication network 100. The user Alice is associated with a set of UEs 120, 121, 122, in a single user subscription. The set of UEs 120, 121, 122 comprises at least a first UE 120, 121 and a second UE 120, 122. The ongoing communication session with the remote party 200 involves the first UE 121. The method comprises the following actions, which actions may be taken in any suitable order. Optional actions are referred to as dashed boxes in FIG. 3.

### Action 301

For each respective UE out of the set of UEs 120, 121, 122, the network node 130 transmits information related to the respective UE's name recognizable by the user Alice, communication capabilities, and communication session status. The information is transmitted to at least one UE 120, 121, 122 out of the set of UEs 120, 121, 122. In this way, the at least one UE 120, 121, 122 receives information relating to other UEs in the set of UEs 120, 121, 122, and is thus enabled to request a session transfer based on the received information. In some embodiments, the network node 130 transmits the information to each UE 120, 121, 122 in the set of UEs 120, 121, 122. In other words, the information will be available by any UE in the set of UEs 120, 121, 122.

In some embodiments, the at least one UE 120, 121, 122 is any one out of the first UE 120, 121 or the second UE 120, 122. In some other embodiments, the at least one UE 120, 121, 122 may also be any other UE out of the set of UEs 120, 121, 122, e.g. a third UE out of the set of UEs 120, 121, 122.

### Action 302

The network node 130 receives a request from the at least one UE 120, 121, 122, requesting to transfer the ongoing communication session from the first UE 120, 121 to the second UE 120, 122. In other words, the request may indicate that the network node 130 shall move the ongoing communication session from the first UE 120, 121 to the second UE 120, 122.

In some embodiments, the request may e.g. be a call pull request or a call push request.

### Action 303

Based on the request, the network node 130 transfers the ongoing communication session from the first UE 120, 121 to the second UE 120, 122.

In some embodiments, the transfer of the ongoing communication session may e.g. be any of a call push or a call pull.

### Action 304

In some embodiments, when the ongoing communication session has been transferred, for each respective UE out of the set of UEs 120, 121, 122, the network node 130 transmits updated information related to the respective UE's name recognizable by the user Alice, communication capabilities, and communication session status. The information is transmitted to at least one UE 120, 121, 122 out of the set of UEs 120, 121, 122. The at least one UE 120, 121, 122 is thus informed of updated information relating to UEs in the set of UEs 120, 121, 122.

In some embodiments, the network node 130 transmits the information to each UE in the set of UEs. In other words, the updated information will be available by any UE in the set of UEs 120, 121, 122.

The above embodiments will now be further explained and exemplified below. The embodiments below may be combined with any suitable embodiment above.

Some embodiments herein are particularly related to pushing and/or pulling calls between UEs, wherein at least of the UEs in the set of UEs 120, 121, 122, is a vehicle. E.g. the first and/or second UE 120, 121, 122 may in some embodiments be a car phone. In this way, using embodiments herein, it is thus possible to push an active call from car phone, e.g. the first UE 120, 121, to a smart phone, e.g. the second UE 120, 122, or to pull an active call to a car phone from a smart phone.

This solves the problems in 3GPP TS 24.337 which e.g. utilizes Globally Routable User Agent URI (GRUU) and Service Centralization and Continuity Application Server (SCC-AS) for Session Continuity (SC) UEs which need to base any transfer of sessions between UEs based on proprietary configurations, i.e. by being preconfigured with addresses, where to transfer sessions, etc.

This is since, using embodiments herein, it is possible for a UE 120, 121, 122, e.g. the device 120, 121, 122, to find addresses of the other UEs in the same subscription, e.g. in the set of UEs 120, 121, 122 described above, and to transfer a session between the other UEs in the set of UEs 120, 121, 122.

In some embodiments end users of UEs, e.g. the set of UEs 120, 121, 122 described above, sharing a single subscription, e.g. IMS subscription, may assign user-friendly device information to its respective UEs. User-friendly device information as used herein may comprise the respective UE's name recognizable by the end user. The user-friendly device information may also comprise the respective UE's communication capabilities and communication session status.

Each respective UE in the set of UEs 120, 121, 122s may then obtain this information, e.g. as in action 201 above. Each respective UE in the set of UEs 120, 121, 122 may then be able to use the device information, e.g. by presenting them on a Graphical User Interface of a UE, and e.g. performing a multi-media session transfer e.g. Call Pull and/or Call Push of an ongoing call, among the UEs, e.g. the first and second UE 120, 121, 122. This may be performed due to a selection by a user, such as the user Alice, e.g. by means of interpreting the user-friendly information of the UEs in the set of UEs 120, 121, 122, e.g. descriptive names of the UEs, and based on this information, select where to transfer the call. This may e.g. relate to action 202 above. In some scenarios the user such as the user Alice, selects a UE from a list displayed in the UE 120, 121, 122. The selected UE indicates to which UE in the set of UEs 120, 121, 122 to push or pull the call. In some scenarios, the selection may also be automated, e.g. to be performed by a device based on some trigger, e.g. when entering, being in proximity to, or starting a vehicle.

Embodiments herein may relate to a wide range of devices, e.g. the set of UEs 120, 121, 122. Each respective UE may be a SIM device or a non-SIM device. The respective UEs may use any attached access type, e.g. any of PS, CS and without cellular access.

In some embodiments herein, Call Pull and/or Call Push service(s) are anchored in an MMTel AS, e.g. the network node 130.

In some embodiments each respective UE in the set of UEs 120, 121, 122, e.g. any one out of: the device 120 the first UE 120, 121 and the second UE 120, 122, may be a registered or unregistered VOLTE or Voice over NR (VoNR) device.

In some embodiments read and/or update procedures using an Ut interface may be executed by a UE in the set of UEs 120, 121, 122 to provide and/or update its own and/or other UEs user-friendly device information. The user-friendly device information may comprise a UE's name to be recognizable by a user, communication capabilities and communication session status.

In some embodiments, a Dialog Event package is extended to comprise some of the features and/or methods herein. This may be e.g. to notify a served user's devices of user-friendly device information, e.g. descriptive names with respective unique device identities, unique device-identity of a subscribed device, and a unique device-identity of device hosting the call. This may e.g. be the information transmitted and obtained in actions 201 and 301 above.

In some embodiments, to allow access and device type independent, e.g. Call Push and/or Call Pull service, below device specific Information may need to be available in all other UEs in the set of UEs 120, 121, 122 within the same subscription. The specific information may be a User-friendly Device Name, this may e.g. be a nick name and/or a descriptive name. The specific information may also be a state of each respective UE in the set of UEs 120, 121, 122. The state may e.g. be idle, indicating that the UE in the set of UEs 120, 121, 122 is not being in call. The state may alternatively be non-idle, in communication, or alerting, e.g. indicating that the UE in the set of UEs 120, 121, 122 is in a call or in a session. In some embodiments, the specific information may also comprise detailed information of the call or session, e.g. specifying the type of media used or other needed capabilities to handle the session.

Some embodiments herein may be part of an enhancement of the Dialog Event Package, e.g. as in IETF RFC 4235. A user, such as the user Alice, may then receive information, e.g. user-friendly device information, about other UEs in the set of UEs 120, 121, 122 of the same subscription, by notifications using the Dialog Event package. Additionally, or alternatively, this information may also be transmitted or obtained by means of a telecommunication business system, over a Ut interface or by any other suitable means.

### Example Scenarios

With reference to below FIGS. 4-7, the following terms and definitions may be used.

A served user Alice (UA-A) may have various devices such as UEs in the set of UEs 120, 121, 122 in multi-device deployment. The user Alice executes Call Push or Call pull procedure among these UEs. The UEs in the set of UEs 120, 121, 122 may e.g. be any of the following UEs which are referenced in the example scenarios illustrated in FIGS. 4-7:
UA-A1: Alice's Smart Phone, a SIM device on PS Access,
UA-A2: Alice's Car Phone, a SIM device on PS Access,
UA-A3: Alice's PDA, a fixed device, also referred to as a Non-SIM-Device, on PS Access, and
UA-A4: Alice's Home Phone, a SIM-Device on CS Access.

The devices UA-A1, UA-A2, UA-A3, and UA-A4, are merely meant to be examples, and the scenarios may also apply for other devices with varying capabilities and/or status.

In the following example scenarios, a Remote Party-B is a remote party, e.g. remote party 200, wherein the served User Alice, UA-A, has an ongoing session from one of its devices to Remote Party B.

In the following example scenarios, an MMTel AS, also referred to as being serving Alice, UA-A. The MMTel AS may allow and/or manage the call push and call pull service(s) among Alice's SIM and/or Non-SIM devices attached on PS and/or CS access. The MMTel AS referenced below may in some embodiments be the network node 130.

FIG. 4 illustrates User-friendly device information manipulation.

In the example scenario illustrated in FIG. 4, manipulation of the supplementary services may take place over the Ut interface, UE to AS, 3GPP, TS 24.623 defines Extensible Markup Language Configuration Access Protocol, (XCAP), over the Ut interface for Manipulating Supplementary Services.

A served user's UEs, e.g. the UEs comprised in the set of UEs 120, 121, 122, may use the Ut interface for communication with an AS for publishing and/or updating its own and/or other UEs user-friendly device information, e.g. setting and/or updating descriptive names. The user-friendly device information may comprise a UE's name to be recognizable by a user, communication capabilities and communication session status.

The served user's UEs user-friendly device information may also be changed by a Base Station System (BSS) and a similar AS procedure as described below will apply.

An IMS Subscriber, Alice UA-A, has in the example scenario of FIG. 4, two UEs called Alice's Smart Phone UA-A1 such as e.g. the first UE 121, and Alice's Home Phone UA-A2, such as e.g. the second UE 122. The IMS Subscriber Alice is served by an AS in multi device deployment. An Extensible Markup Language Document Management Server (XDMS) is acting as XCAP Server, e.g. which handles Alice's user-friendly device information change request over a Ut interface.

The AS and XDMS are logical subcomponent of an IMS AS providing MMTel Supplementary services to served user Alice. In some embodiments the parts may be comprised in the network node 130. In some embodiments, the network node 130 may be configured to perform the actions of the AS and/or the XDMS described in the following example scenario.

The example scenario illustrated in FIG. 4 comprises the following actions:

Action 401: The UA-A1 performs an IMS Registration. The AS learns about the served user Alice's multiple UEs and their respective user-friendly additional devices information e.g. by fetching the UE transparent service data, e.g. from Home Subscriber Server (HSS). Transparent service data herein means data only meaningful for the AS and not part of a data model in HSS.

Action 402: The UA-A1 subscribes to the AS for Dialog-Event package to get notification(s) from the AS when a dialog status changes in any of Alice's UEs in the set of UEs 120, 121, 122, or when Alice's UEs in the set of UEs 120, 121, 122 user-friendly device information changes.

Action 403: The AS acknowledges the successful subscription of the Dialog-Event package to Alice's Smart Phone UA-A1.

Action 404: The AS sends a Dialog-Event package notification message to Alice's Smart Phone UA-A1 comprising a complete list of Alice's UEs comprised in the set of UEs 120, 121, 122. The complete list comprises, for each respective UE out of the set of UEs 120, 121, 122, user-friendly device information relating to the respective UE in the set of UEs 120, 121, 122, respective unique device identities and dialog status if any. This may e.g. relate to actions 201, 301 above.

Action 405-8: The UA-A2 performs similar actions as performed by the UA-A1. This may e.g. relate to actions 201, 301 above.

Action 409: The UA-A2 modifies the user-friendly device information of device UA-A2. This may e.g. for example be a change of a name of the UA-A2 to “Alice's Personal Phone”, e.g. over the Ut interface. It may alternatively or additionally be a change of communication capabilities and/or communication session status.

Action 410: The XDMS notifies the AS about a change in Alice's devices user-friendly device information, i.e., the name changes in UA-A2.

Action 411: The AS sends a Dialog-Event Package notification message to Alice's Smart Phone UA-A1 about the name change of UA-A2. Alice's Smart Phone UA-A1 considers Alice's Personal Phone as a new name of UA-A2 device. This may e.g. relate to actions 201, 301 above.

Action 412: The AS sends a Dialog-Event Package notification message to Alice's Home Phone UA-A2 about the name change in UA-A2. This may e.g. relate to actions 201, 301 above. Alice's Home Phone UA-A1 acknowledges the name change of UA-A2.

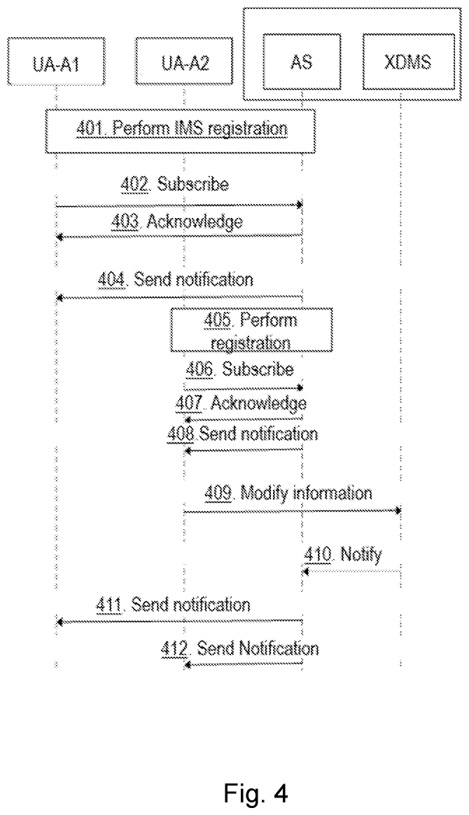

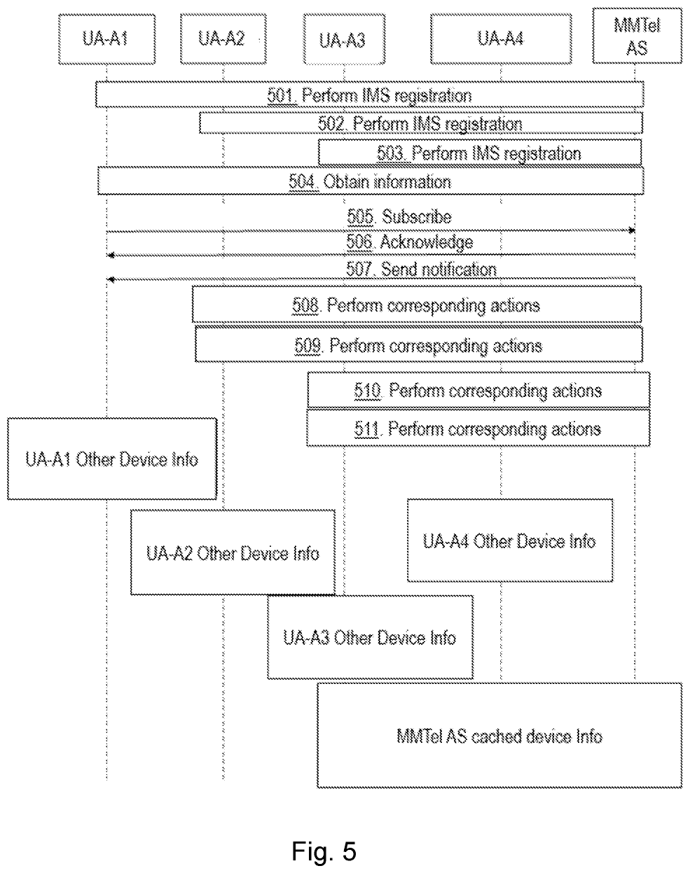

FIG. 5 illustrates an example scenario comprising UE discovery and session discovery according to some embodiments herein.

In this example scenario, the user Alice is associated with UEs: UA-A1 such as e.g. the first UE 121, UA-A2 such as e.g. the second UE 122, UA-A3 such as e.g. a third UE comprised in the set of UEs 120, 121, 122, and UA-A4 such as e.g. a fourth UE comprised in the set of UEs 120, 121, 122. These UEs may be comprised in the set of UEs 120, 121, 122, referred to above, e.g. with reference to actions 201-204 and/or actions 301-304. The UEs may e.g. be any of, the device 120 the first UE 120, 121, and the second UE 120, 122. An MMTel AS may serve above UE, e.g. providing a media session to or from the UEs 120, 121, 122, e.g. and to or from the remote party 200. The MMTel AS may be the network node 130. A session herein may be referred to as an ongoing dialog or an ongoing call. User-friendly information used herein may be the respective UE's name recognizable by the user, communication capabilities, and communication session status and may relate to the obtained and/or transmitted information in actions 201, 204, 301, 304 above.

In the example scenario of FIG. 5, Alice's UEs are enabled to identify UEs of same user, i.e. Alice, for call pull and call push procedures, e.g. to enable pushing and pulling sessions among the UE's 120, 121, 122 in the set of UEs 120, 121, 122. In cases, Alice's devices may also to discover the sessions hosted on some of Alice's devices.

The example scenario illustrated in FIG. 5 comprises the following actions:

Action 501-503: The UA-A1, UA-A2 and UA-A3 performs IMS Registration. The MMTel AS learns about the served user Alice's multiple UEs 120, 121, 122 and their user-friendly device information. This may be performed by fetching the UE transparent service data from HSS.

Action 504: The UA-A1 reads, e.g. obtains, user-friendly device information of Alice's UEs 120, 121, 122, e.g. over a Ut interface. This may relate to action 201 above. The user-friendly device information may comprise a UE's name to be recognizable by a user, communication capabilities and communication session status.

Action 505: The UA-A1 subscribes to the MMTel AS for Dialog-Event package to e.g. get a notification by the MMTel AS, e.g. when Alice's UEs 120, 121, 122 dialog status change, and/or when any of Alice's UEs 120, 121, 122 user-friendly device information changes.

Action 506: The MMTel AS acknowledges the successful subscription of Dialog-Event package to Alice's Smart Phone UA-A1.

Action 507: The MMTel AS sends a Dialog-Event package notification message to Alice's Smart Phone UA-A1. This message may e.g. comprise a complete list of Alice's UEs 120, 121, 122 user-friendly device information with respective unique device identities. This may e.g. relate to actions 201, 301 above. In this way the user Alice has in UA-A1, a consolidated view of Alice's UEs 120, 121, 122 user-friendly device information, described at the end of call flow. Consolidated when used herein means a combined set of information, e.g. the user-friendly device information of all UEs in the set of UEs 120, 121, 122. The consolidated view may comprise a list of other UEs 120, 121, 122 information, e.g. comprising a UE identity, a name, a tag, and status indicator for each UE 120, 121, 122. The list may comprise e.g. the following information:
1. UA-A2: Alice's Car Phone, Tag2, Idle,
2. UA-A3: Alice's PDA, Tag3, Idle, and
3. UA-A4: Alice's Home Phone, Tag4, Idle.

This consolidated view will help the user Alice and Alice's Smart Phone UA-A1 to select an appropriate UE and a session e.g., to push the selected session from Alice's Smart Phone to the selected UE of the same served user or to pull the selected session from the selected UE of the same served user to Alice's Smart Phone UA-A1.

Action 508-511: The UA-A2 and UA-A3 may also perform the same steps as done by the UA-A1. In this way the user Alice has, in the UA-A2, a consolidated view of Alice's UEs 120, 121, 122 user-friendly device information. The consolidated view may in, UA-A2, comprise a list of other UEs 120, 121, 122 information, e.g. comprising a UE identity, a name, a tag, and status indicator for each UE 120, 121, 122. The list may comprise e.g. the following information:
1. UA-A1: Alice's Smart Phone, Tag1, Idle,
2. UA-A3: Alice's PDA, Tag3, Idle, and
3. UA-A4: Alice's Home Phone, Tag4, Idle.

This consolidated view will help the user Alice and the UA-A2 to select an appropriate UE and a session e.g., to push the selected session from Alice's Car Phone UA-A2 to the selected UE device of the same served user, or to pull the selected session from the selected UE of the same served user to Alice's Car Phone UA-A2.

Furthermore, in this way, the user Alice has, in the UA-A3, also a consolidated view of Alice's UEs 120, 121, 122 user-friendly device information. The consolidated view in the UA-A3 may comprise a list of other UEs 120, 121, 122 information, e.g. comprising a device identity, a name, a tag, and status indicator for each device. The list in UA-A3 may comprise e.g. the following information:
1. UA-A1: Alice's Smart Phone, Tag1, Idle,
2. UA-A2: Alice's Car Phone, Tag2, Idle,
3. UA-A4: Alice's Home Phone, Tag4, Idle.

This consolidated view will help the Alice and the UA-A3 to select an appropriate UE and a session, to push the selected session from Alice's PDA UA-A3 to the selected UE of same served user, or to pull the selected session from the selected UE of the same served user to Alice's PDA UA-A3.

However, Alice's Home Phone UA-A4 may not have a consolidated view of Alice's UEs 120, 121, 122 user-friendly information since it is on CS access. However, Alice's Home Phone UA-A4 user-friendly device information and dialog status is still available to other UEs 120, 121, 122, e.g., for pushing a call to Alice's Home Phone UA-A4, or for pulling a call from Alice's Home Phone UA-A4.

The MMTel AS may also have a cached view of user-friendly device information, e.g. comprising a UE identity, a name, a tag, identifiers, capabilities, for each UE 120, 121, 122. The list may comprise e.g. the following information:
1. UA-A1: Alice's Smart Phone, Tag1, Mobile Subscriber Integrated Services Digital Network Number (MSISDN) 1, international mobile subscriber identity (IMSI) 1, International Mobile Equipment Identity (IMEI) 1, Circuit Switched Capable (CSCapable),
2. UA-A2: Alice's Car Phone, Tag2, IMAP2, MSISDN2, IMSI2, IMEI2, CSCapable,
3. UA-A3: Alice's PDA, Tag3, Internet Protocol Multimedia Private Identity (IMPI) 3, Universally Unique Identifier (UUID) 3, and
4. UA-A4: Alice's Home Phone, Tag4, IMPI4, MSISDN4, IMSI4, CSCapable.

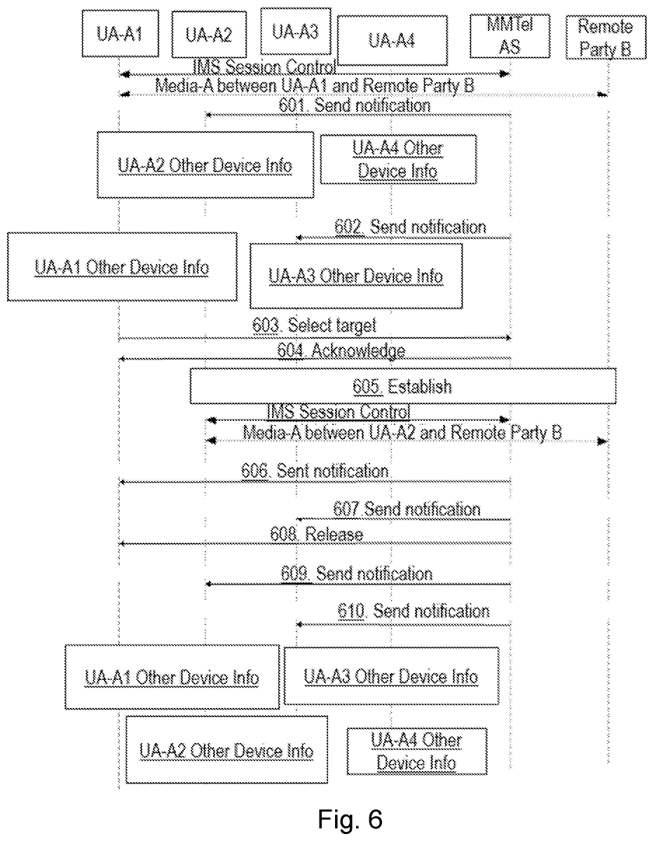

FIG. 6 illustrates an example scenario of embodiments herein wherein the User, Alice, has a Smart Phone, UA-A1, which has an ongoing call, Media-A, with a Remote Party B, e.g. the remote party 200. There is an IMS Session Control between the MMTel AS and the UA-A1. In this example scenario, the UA-A1 may be the device 120 and the first UE 120, 121 in the set of UEs 120, 121, 122. The UA-A2 may be the second UE 120, 122 in the set of UEs 120, 121, 122. In the example scenario, the user Alice may also be associated with UEs UA-A3 such as e.g. a third UE comprised in the set of UEs 120, 121, 122, and UA-A4 such as e.g. a fourth UE comprised in the set of UEs 120, 121, 122. The MMTel AS in this example scenario may be the network node 130. A session herein may be referred to as an ongoing dialog or an ongoing call. User-friendly device information used in this example scenario may be the respective UE's in the set of UEs 120, 121, 122 name recognizable by the user Alice, communication capabilities, and communication session status and may relate to the obtained and/or transmitted information in actions 201, 204, 301, 304 above.

In the example scenario illustrated in FIG. 6, Alice's Smart Phone UA-A1 has a consolidated view of Alice's UEs 120, 121, 122, e.g. in the set of UEs 120, 121, 122, user-friendly device information along with respective status of dialogs hosted on each of Alice's UEs 120, 121, 122. Consolidated when used herein means a combined set of information, e.g. the user-friendly device information of all UEs in the set of UEs 120, 121, 122. In this way, the user Alice is enabled to select Alice's Car Phone UA-A2 as a UE to push Alice's Smart Phone's UA-A1 ongoing session to Alice's Car Phone UA-A2.

The example scenario illustrated in FIG. 6 comprises the following actions:

Action 601: MMTel AS sends a Dialog-Event package notification message to Alice's Car Phone UA-A2 to inform about an ongoing call on Alice's Smart Phone UA-A1. The message comprises a UE unique identity of the Smart Phone UA-A1. This may e.g. relate to actions 201, 301 above. Alice's Car Phone UA-A2 maps Alice's Smart Phone's UA-A1 ongoing call with Alice's Smart Phone UA-A1 user-friendly device information e.g. using a UE unique identity of the Smart Phone UA-A1. This enables Alice's Car Phone UA-A2 to perform call pull or push among Alice's UEs 120, 121, 122 using an updated consolidated view of Alice's UEs 120, 121, 122.

Action 602: MMTel AS sends a Dialog-Event package Notification message to Alice's PDA UA-A3 to inform about the ongoing call on Alice's Smart Phone UA-A1. The message may comprise a UE unique identity of the Smart Phone UA-A1. This may e.g. relate to actions 201, 301 above. Alice's PDA UA-A3 maps the Alice's Smart Phone UA-A1 ongoing call with Alice's Smart Phone UA-A1 user-friendly device information e.g., by the using UE unique identity of the Smart Phone UA-A1. This enables Alice's PDA UA-A3 to perform call pull or push among Alice's UEs 120, 121, 122 through updated consolidated view of Alice's UEs 120, 121, 122.

Action 603: Alice's Smart Phone UA-A1 selects Alice's Car Phone UA-A2 as a selected UE to push its ongoing session to Alice's Car Phone UA-A2. This may e.g. be performed by selection or indication by the user Alice.

Action 604: The MMTel AS acknowledges the call push request.

Action 605: The MMTel AS establishes a session access leg, also referred to as a media access leg, e.g. a connection comprising the ongoing session, with Alice's Car Phone UA-A2. A leg used herein means a communication session. The MMTel AS may also perform media re-negotiation with the Remote party B. An IMS session and media path may then be established between Alice's Car Phone UA-A2 and the Remote party B. This may e.g. relate to action 303 above.

Action 606: The MMTel AS sends a Dialog-Event package Notification message to Alice's Smart Phone UA-A1 to inform about the ongoing call on Alice's Car Phone UA-A2 with UE unique identity comprising a UE unique identity of the Car Phone UA-A2. This may e.g. relate to actions 204, 304 above. Alice's Smart Phone UA-A1 maps Alice's Car Phone's UA-A2 ongoing call with Alice's Car Phone's UA-A2 user-friendly device information using the UE unique identity of the Car Phone UA-A2. This enables Alice's Smart Phone UA-A1 to perform call pull or push among Alice's UEs 120, 121, 122 through an updated consolidated view of Alice's UEs 120, 121, 122.

Action 607: The MMTel AS sends a Dialog-Event package Notification message to Alice's PDA UA-A3 to inform about ongoing call on Alice's Car Phone UA-A2. The message comprising a UE unique identity of the UA-A2. This may e.g. relate to actions 204, 304 above. Alice's PDA UA-A3 maps Alice's Car Phone's UA-A2 ongoing call with Alice's Car Phone UA-A2 user-friendly device information by using the UE unique identity of the Car Phone UA-A2. This enables Alice's PDA UA-A3 to perform call pull or push among Alice's UEs 120, 121, 122 through an updated consolidated view of Alice's UEs 120, 121, 122.

Action 608: The MMTel AS releases the session access leg towards Alice's Smart Phone UA-A1. This may e.g. relate to action 303 above.

Action 609: The MMTel AS sends a Dialog-Event package Notification message to Alice's Car Phone UA-A2 to inform about no call on Alice's Smart Phone UA-A1. This may e.g. relate to actions 204, 304 above. This enables Alice's Car Phone UA-A2 to perform call pull or push among Alice's UEs 120, 121, 122 through an updated consolidated view of Alice's UEs 120, 121, 122.

Action 610: The MMTel AS sends a Dialog-Event package Notification message to Alice's PDA UA-A3 to inform about no call on Alice's Smart Phone UA-A1. This may e.g. relate to actions 204, 304 above. This enables Alice's PDA UA-A3 to perform call pull or push among Alice's UEs 120, 121, 122 through an updated consolidated view of Alice's UEs 120, 121, 122.

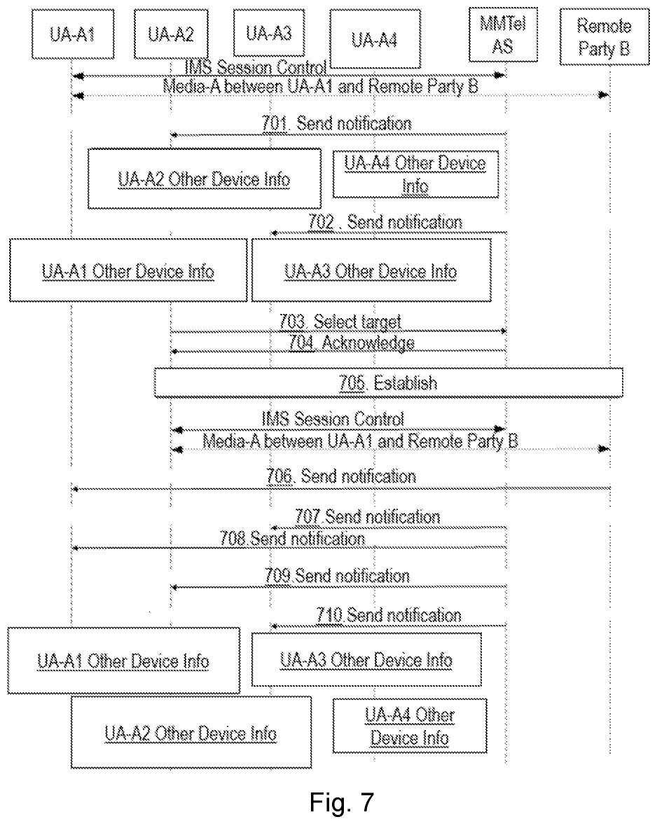

FIG. 7 illustrates an example scenario of embodiments herein wherein a User, Alice, has a Smart Phone, UA-A1, which has an ongoing call, Media-A, with Remote Party B, e.g. the remote party 200. There is an IMS Session Control between the MMTel AS and the UA-A1. In this example scenario, UA-A2 may be the device 120 and second UE 120, 122 in the set of UEs 120, 121, 122. The UA-A1 may be the first UE 120, 121 in the set of UEs 120, 121, 122. In the example scenario, the user Alice may also be associated with UEs UA-A3 such as e.g. a third UE comprised in the set of UEs 120, 121, 122, and UA-A4 such as e.g. a fourth UE comprised in the set of UEs 120, 121, 122. The MMTel AS in this example scenario may be the network node 130. A session herein may be referred to as an ongoing dialog or an ongoing call. User-friendly information used herein may be respective UE's name recognizable by the user, communication capabilities, and communication session status and may relate to the obtained and/or transmitted information in actions 201, 204, 301, 304 above.

In this example scenario, a call pull is initiated by Alice's Car Phone, UA-A2, for pulling a session, e.g. the ongoing call, from Alice's Smart Phone, UA-A1. Alice's Car Phone UA-A2 has a consolidated view of Alice's UEs 120, 121, 122 user-friendly device information along with status of dialog hosted on the Alice's UEs 120, 121, 122. Consolidated when used herein means a combined set of information, e.g. the user-friendly device information of all UEs in the set of UEs 120, 121, 122. In this way, this allows the user Alice and Alice's Car Phone UA-A2 to select Alice's Smart Phone UA-A1 as a selected UE to pull Alice's Smart Phone UA-A1 ongoing call to Alice's Car Phone UA-A2. The user-friendly device information may comprise a UE's name to be recognizable by a user, communication capabilities and communication session status.

The example scenario illustrated in FIG. 7 comprises the following actions:

Action 701: MMTel AS sends a Dialog-Event package Notification message to Alice's Car Phone UA-A2 to inform about an ongoing call on Alice's Smart Phone UA-A1. The message comprises a UE unique identity of the Smart Phone UA-A1. This may e.g. relate to actions 201, 301 above. Alice's Car Phone UA-A2 maps Alice's Smart Phone UA-A1 ongoing session with Alice's Smart Phone's UA-A1 user-friendly device information. This may be performed by mapping the UE unique identity, e.g. of Alice's Smart Phone UA-A1 with the user-friendly device information. In this way, the user Alice and Alice's Car Phone UA-A2 is enabled to perform call pull or push among Alice's UEs 120, 121, 122 through an updated consolidated view of Alice's UEs 120, 121, 122.

Action 702: The MMTel AS sends a Dialog-Event package Notification message to Alice's PDA UA-A3 to inform about the ongoing session on Alice's Smart Phone UA-A1. The message comprises the UE unique identity of the Smart Phone UA-A1. This may e.g. relate to actions 201, 301 above. Alice's PDA UA-A3 maps Alice's Smart Phone UA-A1 ongoing session with Alice's Smart Phone's UA-A1 user-friendly device information, e.g. using the UE unique identity of the Smart Phone UA-A1. This enables Alice's PDA UA-A3 to perform a call pull or push among Alice's UEs 120, 121, 122 through updated consolidated view of Alice's UEs 120, 121, 122.

Action 703: Alice's Car Phone UA-A2 selects Alice's Smart Phone UA-A1 as a selected UE for pulling Alice's Smart Phone's UA-A1 ongoing session to Alice's Car Phone UA-A2. This is performed by the Car Phone UA-A2, sending to the MMTel AS, a call pull request. This may e.g. relate to actions 202, 203, 302 above.

Action 704: The MMTel AS acknowledges the call pull request.

Action 705: The MMTel AS establishes a session access leg, also referred to as a media access leg, e.g. a connection comprising the ongoing session, with Alice's Car Phone UA-A2. The MMTel AS may also perform Media re-negotiation with the Remote party B. An IMS session and media path may then be established between Alice's Car Phone UA-A2 and Remote party B. This may e.g. relate to action 303 above.

Action 706: The MMTel AS sends a Dialog-Event package Notification message to Alice's Smart Phone UA-A1 to inform about the ongoing call on Alice's Car Phone UA-A2 comprising a UE unique identity of the Car Phone UA-A2. This may e.g. relate to actions 204, 304 above. Alice's Smart Phone UA-A1 maps the Alice's Car Phone UA-A2 ongoing session, with Alice's Car Phone UA-A2 user-friendly device information using the UE unique identity of the Car Phone UA-A2. This enables Alice's Smart Phone UA-A1 to perform call pull or push among Alice's UEs 120, 121, 122 through an updated consolidated view of Alice's UEs 120, 121, 122.

Action 707: The MMTel AS sends a Dialog-Event package Notification message to Alice's PDA UA-A3 to inform about the ongoing call on Alice's Car Phone UA-A2 comprising the UE unique identity of the Car Phone UA-A2. This may e.g. relate to actions 204, 304 above. Alice's PDA UA-A3 maps the Alice's Car Phone UA-A2 ongoing dialog with Alice's Car Phone's UA-A2 user-friendly device information using the UE unique identity of the Car Phone UA-A2. This enables Alice's PDA UA-A3 to perform call pull or push among Alice's UEs 120, 121, 122 through an updated consolidated view of Alice's UEs 120, 121, 122.

Action 708: The MMTel AS releases the session access leg towards Alice's Smart Phone UA-A1. This may e.g. relate to action 303 above.

Action 709: The MMTel AS sends a Dialog-Event package Notification message to Alice's Car Phone UA-A2 to inform about no call on Alice's Smart Phone UA-A1. This may e.g. relate to actions 204, 304 above. This enables Alice's Car Phone UA-A2 to perform call pull or push among Alice's UEs 120, 121, 122 through an updated consolidated view of Alice's UEs 120, 121, 122.

Action 710: The MMTel AS sends a Dialog-Event package Notification message to Alice's PDA UA-A3 to inform about no call on Alice's Smart Phone UA-A1. This may e.g. relate to actions 204, 304 above. This enables Alice's PDA UA-A3 to perform call pull or push among Alice's UEs 120, 121, 122 through an updated consolidated view of Alice's UEs 120, 121, 122.

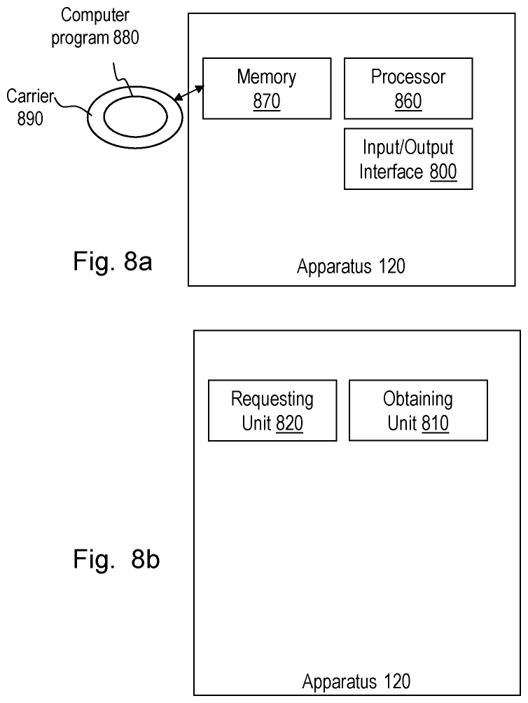

To perform the method actions above, the device 120 is configured to handle an ongoing communication session with the remote party 200 in the communication network 100. A user Alice is arranged to be associated with a set of User Equipments, UEs, in a single user subscription. The set of UEs is adapted to comprise at least the first UE 120, 121 and the second UE 120, 122. The ongoing communication session with the remote party 200 is adapted to involve the first UE 120, 121. The device 120 may comprise an arrangement depicted in FIGS. 8a and 8b.

The device 120 may comprise an input and output interface 800 configured to communicate with network nodes such as the network node 130. The input and output interface 800 may comprise a wireless receiver (not shown) and a wireless transmitter (not shown).

The device 120 may further be configured to, e.g. by means of a obtaining unit 810 in the device 120, for each respective UE out of the set of UEs, obtain information related to the respective UE's name recognizable by the user Alice, communication capabilities, and communication session status.

The device 120 may further be configured to, e.g. by means of the obtaining unit 810 in the device 120, obtain a user indication based on the received information, which indication is adapted to indicate to transfer the ongoing communication session with the remote party 200.

The device 120 may further be configured to, e.g. by means of the obtaining unit 810 in the device 120, when the ongoing communication session has been transferred, for each respective UE out of the set of UEs, obtain updated information related to the respective UE's name recognizable by the user Alice, communication capabilities, and communication session status.

The device 120 may further be configured to, e.g. by means of the obtaining unit 810 in the device 120, obtain information related to the respective UE's name recognizable by the user Alice, communication capabilities, and communication session status by: retrieving the information from the device performing the method, or receiving the information from the network node 130.

The device 120 may further be configured to, e.g. by means of a requesting unit 820 in the device 120, according to the indication, request a network node 130 to transfer the ongoing communication session from the first UE 120, 121 to the second UE 120, 122.

The device 120 may further be configured to, e.g. by means of the requesting unit 820 in the device 120,

The device 120 may further be configured to, e.g. by means of the requesting unit 820 in the device 120,

The device 120 may further be configured to, e.g. by means of the requesting unit 820 in the device 120,

In some embodiments, the communication session status is adapted to comprise any one or more out of:
whether being involved in the ongoing session,
whether not being involved in the ongoing session, and
a current status of another session than the ongoing session.

In some embodiments, the name recognizable by the user Alice is adapted to be any one out of:
a descriptive name set by a user,
a descriptive name set by an operator, and
a descriptive name automatically generated.

In some embodiments, the information related to the respective UE's name recognizable by the user Alice, communication capabilities, and communication session status, further is adapted to comprise device information. In these embodiments the device information is adapted to comprising any one or more out of:
a tag indicating the UE supports one or more types of media,
a tag indicating the UE supports one or more types of communication, and
a tag indicating the UE have registered one or more capabilities associated with the UE.

In some embodiments, the device 120 is adapted to be represented by any one out of the first UE 120, 121 or the second UE 120, 122.

In some embodiments, the received information is adapted to be presented by the first UE 120, 121 or the second UE 120, 122 to be recognized by the user Alice.

The embodiments herein may be implemented through a respective processor or one or more processors, such as the processor 860 of a processing circuitry in the device 120 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the device 120. One such carrier may be in the form of a CD ROM disc. It is however feasible with other data carriers such as a memory stick. The computer program code may furthermore be provided as pure program code on a server and downloaded to the device 120.

The device 120 may further comprise a memory 870 comprising one or more memory units. The memory 870 comprises instructions executable by the processor in device 120. The memory 870 is arranged to be used to store e.g. information, indications, data, configurations, and applications to perform the methods herein when being executed in the device 120.

In some embodiments, a computer program 880 comprises instructions, which when executed by the respective at least one processor 860, cause the at least one processor of the device 120 to perform the actions above.

In some embodiments, a respective carrier 890 comprises the respective computer program 880, wherein the carrier 890 is one of an electronic signal, an optical signal, an electromagnetic signal, a magnetic signal, an electric signal, a radio signal, a microwave signal, or a computer-readable storage medium.

Those skilled in the art will appreciate that the units in the device 120 described above may refer to a combination of analog and digital circuits, and/or one or more processors configured with software and/or firmware, e.g. stored in the device 120 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

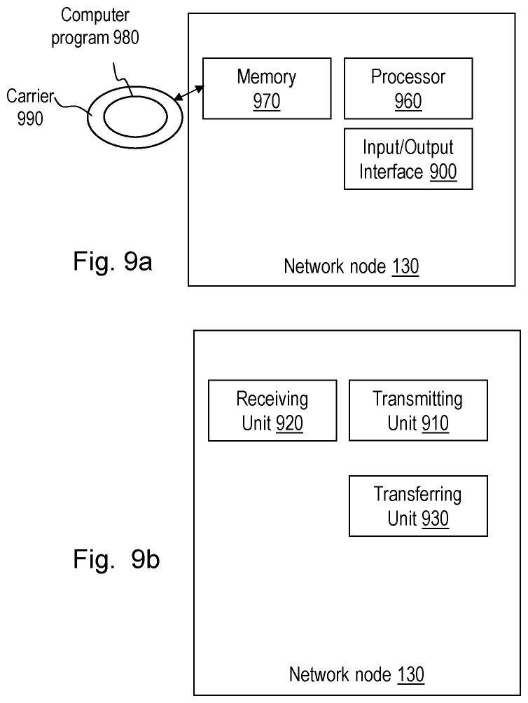

To perform the method actions above, the network node 130 is configured to handle an ongoing communication session with the remote party 200 in the communication network 100. A user Alice is arranged to be associated with a set of User Equipments, UEs, in a single user subscription. The set of UEs is adapted to comprise at least the first UE 120, 121 and the second UE 120, 122. The ongoing communication session with the remote party 200 is adapted to involve the first UE 121. The network node 130 may comprise an arrangement depicted in FIGS. 9a and 9b.

The network node 130 may comprise an input and output interface 900 configured to communicate with the device 120, the first UE 120, 121, and/or the second UE 120, 122. The input and output interface 900 may comprise a wireless receiver (not shown) and a wireless transmitter (not shown).

The network node 130 may further be configured to, e.g. by means of a transmitting unit 910 in the network node 130, for each respective UE out of the set of UEs, transmit, information related to the respective UE's name recognizable by the user Alice, communication capabilities, and communication session status, which information is arranged to be transmitted to at least one UE 120, 121, 122 out of the set of UEs.

The network node 130 may further be configured to, e.g. by means of the transmitting unit 910 in the network node 130, transmit information related to the respective UE's name recognizable by the user Alice, communication capabilities, and communication session status, by transmitting the information to each UE in the set of UEs.

The network node 130 may further be configured to, e.g. by means of the transmitting unit 910 in the network node 130, when the ongoing communication session has been transferred, for each respective UE out of the set of UEs, transmit updated information related to the respective UE's name recognizable by the user Alice, communication capabilities, and communication session status, which information is arranged to be transmitted to at least one UE 120, 121, 122 out of the set of UEs.

The network node 130 may further be configured to, e.g. by means of a receiving unit 920 in the network node 130, receive a request from the at least one UE 120, 121, 122, requesting to transfer the ongoing communication session from the first UE 120, 121 to the second UE 120, 122.

The network node 130 may further be configured to, e.g. by means of the receiving unit 920 in the network node 130,

The network node 130 may further be configured to, e.g. by means of a transferring unit 930 in the network node 130, based on the request, transfer the ongoing communication session from the first UE 120, 121 to the second UE 120, 122.

The network node 130 may further be configured to, e.g. by means of the transferring unit 930 in the network node 130,

In some embodiments, the at least one UE 120, 121, 122 is adapted to be represented by any one out of the first UE 120, 121 or the second UE 120, 122.

The embodiments herein may be implemented through a respective processor or one or more processors, such as the processor 960 of a processing circuitry in the network node 130 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the network node 130. One such carrier may be in the form of a CD ROM disc. It is however feasible with other data carriers such as a memory stick. The computer program code may furthermore be provided as pure program code on a server and downloaded to the network node 130.

The network node 130 may further comprise a memory 970 comprising one or more memory units. The memory 970 comprises instructions executable by the processor in network node 130. The memory 970 is arranged to be used to store e.g. information, indications, data, configurations, and applications to perform the methods herein when being executed in the network node 130.

In some embodiments, a computer program 980 comprises instructions, which when executed by the respective at least one processor 960, cause the at least one processor of the network node 130 to perform the actions above.

In some embodiments, a respective carrier 990 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the network node 130 described above may refer to a combination of analog and digital circuits, and/or one or more processors configured with software and/or firmware, e.g. stored in the network node 130, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

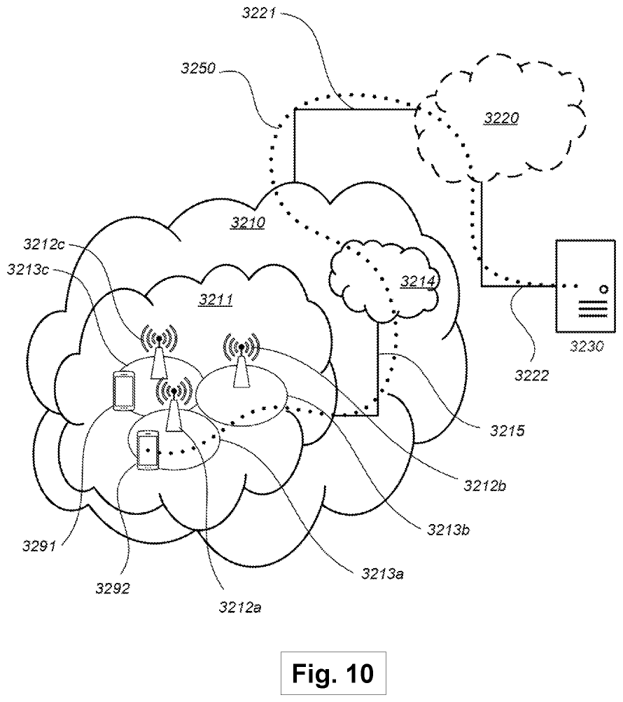

With reference to FIG. 10, in accordance with an embodiment, a communication system includes a telecommunication network 3210, e.g. communication network 100, such as a 3GPP-type cellular network, which comprises an access network 3211, such as a radio access network, and a core network 3214. The access network 3211 comprises a plurality of base stations 3212a, 3212b, 3212c, such as AP STAs NBs, eNBs, gNBs, e.g. network node 130, or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE), e.g. device 120 or the first or second UE 120, 121, 122, such as a Non-AP STA 3291 located in coverage area 3213c is configured to wirelessly connect to, or be paged by, the corresponding base station 3212c. A second UE 3292, e.g. the device 120 or the first or second UE 120, 121, 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

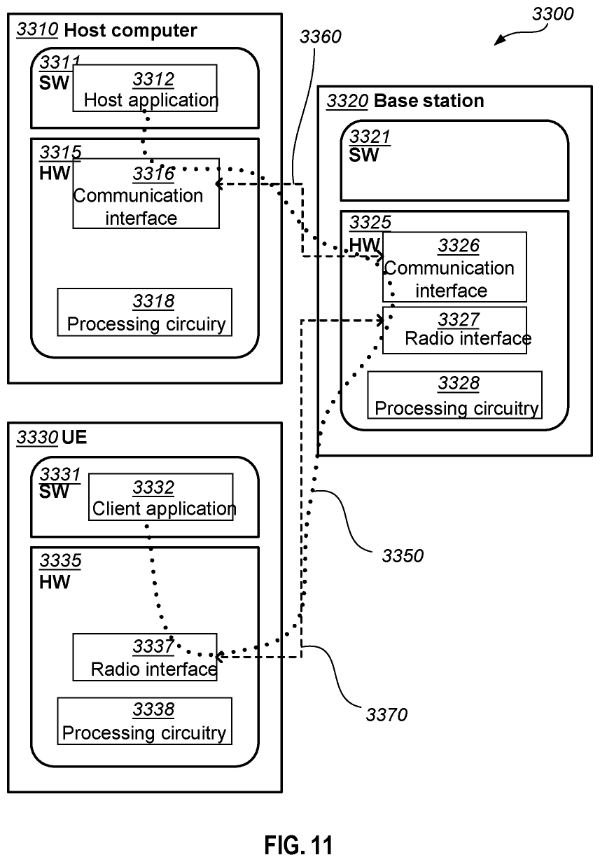

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 20) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption, and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

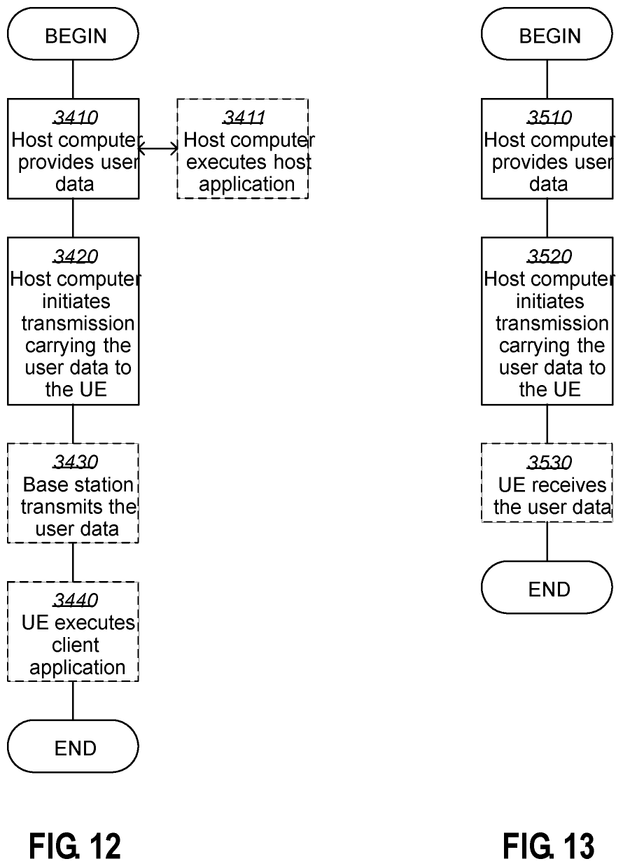

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 12 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 13 will be included in this section. In a first step 3510 of the method, the host computer provides user data. In an optional sub step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

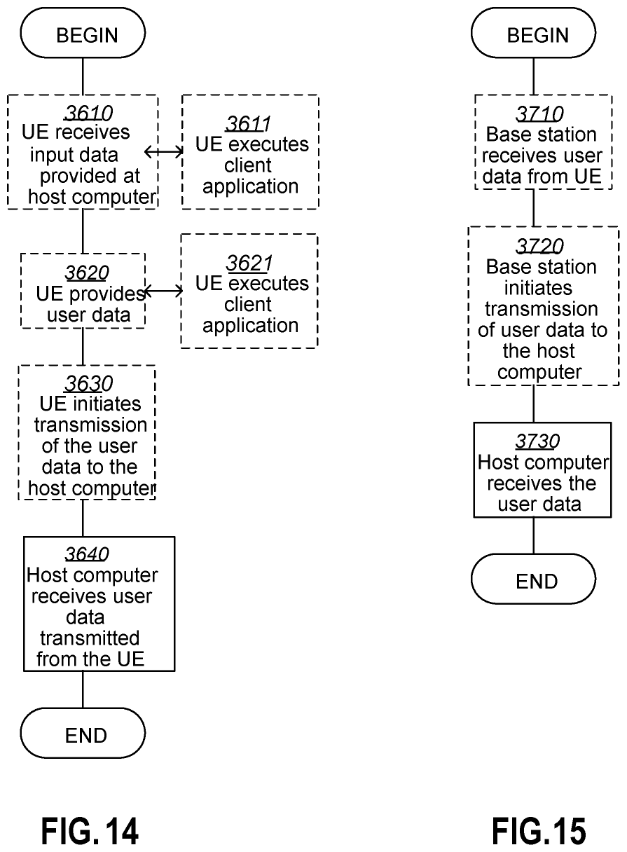

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional sub step 3621 of the second step 3620, the UE provides the user data by executing a client application. In a further optional sub step 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub step 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### Abbreviations

Some abbreviations which may be used above are listed below.

| Abbreviation | Explanation |
|---|---|
| GUI | Graphical User Interface |
| PS | Packet Switched |
| CS | Circuit Switched |
| SIM | Subscriber Identity Module |
| AS | Application Server |
| XDMS | XML Document Management Server |
| SC | Service Continuity |
| VoLTE | Voice over LTE |
| HSS | Home Subscriber Server |

1. A method for handling an ongoing communication session with a remote party in a communication network, a user being associated with a set of User Equipments, UEs, in a single user subscription, which set of UEs comprises at least a first UE and a second UE, the ongoing communication session with the remote party involving the first UE, the method comprising:
for each respective UE out of the set of UEs, obtaining information related to the respective UE's name recognizable by the user, communication capabilities, and communication session status;
obtaining a user indication based on the received information, which indication indicates to transfer the ongoing communication session with the remote party; and
according to the indication, requesting a network node to transfer the ongoing communication session from the first UE to the second UE.

2. The method according to claim 1, further comprising: when the ongoing communication session has been transferred, for each respective UE out of the set of UEs, obtaining updated information related to the respective UE's name recognizable by the user, communication capabilities, and communication session status.

3. The method according to claim 1, wherein the communication session status comprises any one or more out of:
whether being involved in the ongoing session;
whether not being involved in the ongoing session; and
a current status of another session than the ongoing session.

4. The method according to claim 1, wherein the name recognizable by the user is any one out of:
a descriptive name set by a user;
a descriptive name set by an operator; and
a descriptive name automatically generated.

5. The method according to claim 1, wherein the information related to the respective UE's name recognizable by the user, communication capabilities, and communication session status, further comprises device information, wherein the device information comprising any one or more out of:
a tag indicating the UE supports one or more types of media;
a tag indicating the UE supports one or more types of communication; and
a tag indicating the UE have registered one or more capabilities associated with the UE.

6. The method according to claim 1, wherein the method is performed by any one out of the first UE or the second UE.

7. The method according to claim 1, wherein obtaining comprises retrieving the information from a device performing the method, or receiving the information from the network node.

8. The method according to claim 1, wherein the received information is presented by the first UE or the second UE to be recognized by the user.

9. (canceled)

10. (canceled)

11. A method performed by a network node, for handling an ongoing communication session with a remote party in a communication network, a user being associated with a set of User Equipments, UEs, in a single user subscription, which set of UEs comprises at least a first UE and a second UE, the ongoing communication session with the remote party involving the first UE, the method comprising:
for each respective UE out of the set of UEs, transmitting information related to the respective UE's name recognizable by the user, communication capabilities, and communication session status, which information is transmitted to at least one UE out of the set of UEs;
receiving a request from the at least one UE, requesting to transfer the ongoing communication session from the first UE to the second UE; and
based on the request, transferring the ongoing communication session from the first UE to the second UE.

12. The method according to claim 11, wherein the at least one UE is any one out of the first UE or the second UE.

13. The method according to claim 11, wherein transmitting information related to the respective UE's name recognizable by the user, communication capabilities, and communication session status, further comprises transmitting the information to each UE in the set of UEs.

14. The method according to claim 11, further comprising:
when the ongoing communication session has been transferred, for each respective UE out of the set of UEs transmitting updated information related to the respective UE's name recognizable by the user, communication capabilities, and communication session status, which information is transmitted to at least one UE out of the set of UEs.

15. (canceled)

16. (canceled)

17. A device configured to handle an ongoing communication session with a remote party in a communication network, a user being arranged to be associated with a set of User Equipments, UEs in a single user subscription, which set of UEs includes at least a first UE and a second UE, the ongoing communication session with the remote party involving the first UE, the device further being configured to:
for each respective UE out of the set of UEs obtain information related to the respective UE's name recognizable by the user, communication capabilities, and communication session status;
obtain a user indication based on the received information, which indication is configured to indicate to transfer the ongoing communication session with the remote party; and
according to the indication, request a network node to transfer the ongoing communication session from the first UE to the second UE.

18. The device according to claim 17, further being configured to:
when the ongoing communication session has been transferred, for each respective UE out of the set of UEs, obtain updated information related to the respective UE's name recognizable by the user, communication capabilities, and communication session status.

19. The device according to claim 17 wherein the communication session status is adapted to comprise any one or more out of:
whether being involved in the ongoing session;
whether not being involved in the ongoing session; and
a current status of another session than the ongoing session.

20. The device according to claim 17, wherein the name recognizable by the user is any one out of:
a descriptive name set by a user,
a descriptive name set by an operator, and
a descriptive name automatically generated.

21. The device according to claim 17, wherein the information related to the respective UE's name recognizable by the user, communication capabilities, and communication session status, further is adapted to comprise device information, wherein the device information is adapted to comprising any one or more out of:
a tag indicating the UE supports one or more types of media;
a tag indicating the UE supports one or more types of communication; and
a tag indicating the UE have registered one or more capabilities associated with the UE.

22. The device according to claim 17, wherein the device is configured to be represented by any one the first UE or the second UE.

23. The device according to claim 17, further configured to obtain information related to the respective UE's name recognizable by the user, communication capabilities, and communication session status by:
retrieving the information from the device performing the method, or receiving the information from the network node.

24. The device according to claim 17, wherein the received information is adapted to be presented by the first UE or the second UE to be recognized by the user.

25. A network node configured to handle an ongoing communication session with a remote party in a communication network, a user being arranged to be associated with a set of User Equipments, UEs in a single user subscription, which set of UEs includes at least a first UE and a second UE, and the ongoing communication session with the remote party involving the first UE, the network node further being configured to:
for each respective UE out of the set of UEs, transmit information related to the respective UE's name recognizable by the user, communication capabilities, and communication session status, which information is arranged to be transmitted to at least one UE out of the set of UEs;
receive a request from the at least one UE, requesting to transfer the ongoing communication session from the first UE to the second UE; and
based on the request, transfer the ongoing communication session from the first UE to the second UE.

26. (canceled)

27. The network node according to claim 25, further configured to transmit information related to the respective UE's name recognizable by the user, communication capabilities, and communication session status, by transmitting the information to each UE in the set of UEs.

28. The network node according to claim 25, further configured to: when the ongoing communication session has been transferred, for each respective UE out of the set of UEs, transmit updated information related to the respective UE's name recognizable by the user, communication capabilities, and communication session status, which information is arranged to be transmitted to at least one UE out of the set of UEs.
